(19) United States
(12) Patent Application Publication
(10) Pub. No.: US 2017/0248515 A1
(43) Pub. Date: Aug. 31, 2017

(54) Flow Cell Cuvettes Having a Narrowing Region, and Flow Cytometer Systems Comprising the Same

(71) Applicant: Becton, Dickinson and Company, Franklin Lakes, NJ (US)

(72) Inventors: Larry D. Duckett, Jr., Morgan Hill, CA (US); David Jay Matsuyama, Manteca, CA (US); Jozsef Dorombozi, Sunnyvale, CA (US)

(21) Appl. No.: 15/509,828

(22) PCT Filed: Oct. 27, 2015
(86) PCT No.: PCT/US15/57584

§ 371 Date: Mar. 8, 2017

Related U.S. Application Data
(60) Provisional application No. 62/080,785, filed on Nov. 17, 2014.

(51) Int. Cl. G01N 21/05; G01N 21/03; G01N 15/14

(52) U.S. Cl. CPC G01N 21/05; G01N 15/1404; G01N 15/1459; G01N 21/0303; G01N 2021/058; G01N 2015/1006

(57) ABSTRACT

Flow cytometer flow cell cuvettes are provided. Aspects of the flow cell cuvettes include a narrowing region having a wide end opposite a narrow end and a flow channel extending from the narrow end of the narrowing region. Aspects of the invention further include flow cytometers including the flow cell cuvettes, and methods of using the same, e.g., in sample analysis.

### CROSS-REFERENCE TO RELATED APPLICATIONS

This application claims priority to United States Provisional Patent Application Ser. No. 62/080,785 filed Nov. 17, 2014, the disclosure of which application is incorporated herein by reference.

### INTRODUCTION

Flow cytometry is a widely used method involving the optical analysis of individual particles suspended in a fluid, and plays an important role in diagnostics, therapeutics, and basic cell biology research. In a flow cytometer, the optical properties of particles, such as beads or cells, are assessed on a particle by particle basis. Optical properties include light scatter (forward scatter, side scatter) and fluorescence. A flow cytometer may have a flow cell cuvette. Sample may be passed through a flow channel of the flow cell cuvette and the optical properties of individual particles in the sample may be assessed at an assay region of the flow channel. The flow cell cuvette may be removable, so as to allow for cleaning of the cuvette or replacement with a different cuvette that alters aspects such as flow rate, shear stress, pressure differential, maximum particle size that may be run, and so forth.

In certain flow cytometers, known as sorting flow cytometers, particles may be separated based on their optical properties. Particles in a segregated stream, detected as having one or more desired optical properties, are individually isolated from the sample stream by mechanical or electrical removal. A common flow sorting technique utilizes drop sorting in which a fluid stream containing linearly segregated particles is broken into drops and the drops containing particles of interest are electrically charged and deflected into a collection tube by passage through an electric field.

### SUMMARY

Flow cytometer flow cell cuvettes are provided. Aspects of the flow cell cuvettes include a narrowing region having a wide end opposite a narrow end and a flow channel extending from the narrow end of the narrowing region. Aspects of the invention further include flow cytometers including the flow cell cuvettes, and methods of using the same, e.g., in sample analysis.

### BRIEF DESCRIPTION OF THE FIGURES

FIGS. 1A-B are schematic representations of the side (A) and top (B) of a flow cell cuvette 102 having a narrowing region 104 in communication with a flow channel 106, according to one embodiment.

FIGS. 2A-B are schematic representations of the side (A) and top (B) of the flow cell cuvette 102 having a cylindrical region 202 in communication with the narrowing region 104, according to one embodiment.

FIG. 3 is a schematic representation of a flow cytometry system 300 having a flow cell cuvette 102 of the subject invention.

FIG. 4 is a schematic representation of a flow cytometry system 300 having a flow cell cuvette 102 of the subject invention and configured to sort particles.

### DEFINITIONS

Before describing exemplary embodiments in greater detail, the following definitions are set forth to illustrate and define the meaning and scope of the terms used in the description.

The term “flow cytometer” as used herein refers to any instrument that analyzes particles suspended in a fluid by passing the particles past one or more optical detectors. Flow cytometers include, for example, analyzing or sorting flow cytometers, hematology analyzers, and cell counters.

The term “index-matched” refers to the close similarity of the refractive index of a material, such as a liquid, cement (adhesive), or gel, to an optical element such as a flow cell cuvette. An index-matching material may be used to reduce optical and chromic aberrations, and to reduce Fresnel reflections, caused by a refractive discontinuity at the surface of an optical element. Index-matching materials are well-known in the art and are commercially available from a number of vendors (for example, Cargille Laboratories, Cedar Grove, N.J.). Using mixtures of the available index-matching materials, an index-matching material having an index of refraction that closely matches the index of refraction of the material (e.g., glass) used in the manufacture of the cuvette can be produced routinely. An “index-matched sheath fluid” is a fluid of a refractive index that matches an optically transmissive portion of the flow cell cuvette.

The term “sample” as used herein refers to a liquid containing particles (e.g., micro-scale cells or beads) to be analyzed by flow cytometry. In certain embodiments, the sample may be in mixture with an index-matched sheath fluid.

The term “cylindrical” as used herein refers to a shape approximating a cylinder. The cross section of a cylindrical region may be circular, but may also be oblong (oval).

The term “frustoconical” as used herein refers to a shape approximating a cone with a tapered tip. It is used in its conventional sense to refer to the shape of a frustum of a cone, where frustum is used in its conventional sense to refer to the basal part of a solid cone or pyramid formed by cutting off the top by a plane parallel to the base. The cross section of a cylindrical region may be circular, but may also be oblong (oval).

The term “axially aligned” as used herein refers to two or more components of the subject invention that are positioned relative to one another such that the centers of the components as measured by cross sections are aligned on the same axis. In certain aspects, axial alignment is described with respect to the axis along the length of the flow channel of the flow cell cuvette.

### DETAILED DESCRIPTION

Flow cytometer flow cell cuvettes are provided. Aspects of the flow cell cuvettes include a narrowing region having a wide end opposite a narrow end and a flow channel extending from the narrow end of the narrowing region. Aspects of the invention further include flow cytometers including the flow cell cuvettes, and methods of using the same, e.g., in sample analysis.

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Methods recited herein may be carried out in any order of the recited events which is logically possible, as well as the recited order of events.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The following detailed description of the figures refers to the accompanying drawings that illustrate exemplary embodiments of a flow cell cuvette and a flow cytometer housing the flow cell cuvette. Other embodiments are possible. Modifications may be made to the embodiments described herein without departing from the spirit and scope of the present invention. Therefore, the following detailed description is not meant to be limiting.

### Flow Cell Cuvette

As described above, aspects of the invention include a flow cytometer flow cell cuvette with a narrowing region. The term flow cell cuvette is used in its conventional sense to refer to a cuvette configure for use as a flow cell. The wide end of the narrowing region is oriented toward an inlet end of the flow cell cuvette. The narrowing region terminates in a narrow end, which is in direct communication with a flow channel of the flow cell cuvette. By narrow end is meant an end having a longest cross-sectional dimension, e.g., diameter, which is shorter than the longest cross-sectional dimension of the wide end. As such, the terms narrow and wide as used to describe this end of the flow channel are used to describe the lengths of the first and second ends of the portion of the channel relative to each other. The flow channel terminates at an outlet end of the flow cell cuvette. In some instances, the narrowing region is configured to hydrodynamically focus a sample into the flow channel. The dimensions of the narrowing region (such as the angle of the sides, the length of the narrowing region, and width of the wide and narrow ends) may be configured to reduce shear force experienced by particles (e.g., cells) that are flowed through the flow cell cuvette. In some instances, the flow channel of the flow cell cuvette as described above is integrated with the remainder of the flow cell cuvette, i.e., is integral with the flow cell cuvette. In these instances, the flow channel is permanently integrated, such that it cannot be removed from, the remainder of the flow cell cuvette without significantly compromising the structure and functionality of the flow cuvette. Cuvettes of the invention may be configured as small tubes of any convenient cross section, e.g., circular or square cross section, and made of any convenient material, e.g., plastic, glass, or fused quartz (for UV light) etc. Cuvettes of embodiments of the invention are monilithic structures (as opposed to composite structures) and in some instances do not include a removable sleeve which bounds the flow through channel of the cuvette. As such, in embodiments the flow through channel is a channel bounds directly by the material the material of the cuvette itself, and not a second material that has been placed in the channel.

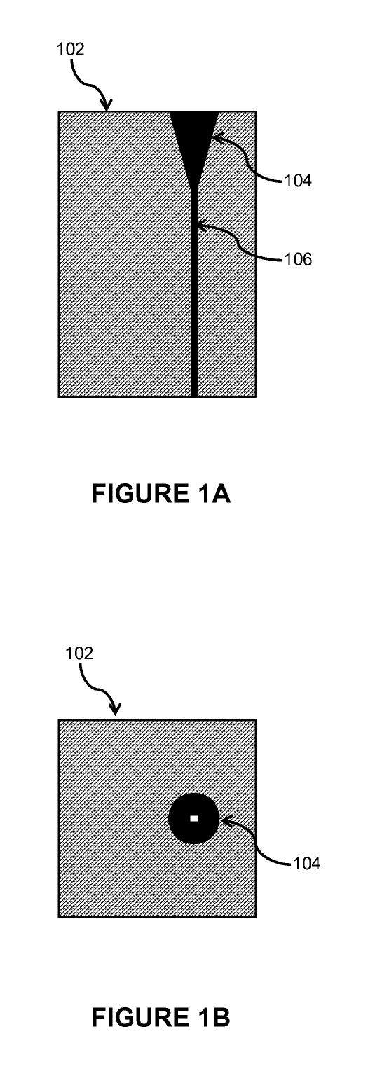

The flow cell cuvettes having now been generally described, embodiments of the cuvettes will be further described in view of the figures. As shown in FIG. 1A, a flow cell cuvette 102 of the subject invention has a narrowing region 104. The narrow end of the narrowing region 104 is in fluidic communication with a flow channel 106. By fluidic communication is meant that, under operating conditions, the channel is configured is configured to receive fluid from the narrowing region. In certain aspects, the narrowing region 104 may be in direct communication with the flow channel 106, such that the narrow end of the narrowing region 104 terminates in the inlet end of the flow channel.

In certain aspects, the narrowing region 104 may be a frusto-conical, e.g., as defined above. The narrowing region 104 may be axially aligned with the flow channel 106. For example, the narrowing region 104 may be centered above the flow channel 106 (e.g., as shown in FIG. 1B) and oriented in the same direction as the flow channel 106 (e.g., as shown in FIG. 1A). The narrowing region 104 and the flow channel 106 may be integrated (e.g., permanently integrated) into the flow cell cuvette 102, e.g., as described above. As shown in FIG. 1A, the narrowing region 104 may extend from the top (inlet) side of the flow cell cuvette 102. The flow channel 106 may extend to the bottom (outlet) side of the flow cell cuvette 102. The axis of the narrowing region 104 and flow channel 106 may be parallel to one or more sides of the flow cell cuvette 102.

The length of the flow cell cuvette 102 as measured between the inlet and outlet ends may vary, and in some instances ranges between 5 mm and 30 mm, 10 mm and 20 mm, 12 mm and 18 mm, 14 mm and 16 mm, and so forth. In some instances, the length of the flow cell cuvette 102 may be 5 mm or more, 10 mm or more, 12 mm or more, 14 mm or more, 16 mm or more, 18 mm or more, 20 mm or more, 30 mm or less, 20 mm or less, 18 mm or less, 16 mm or less, 14 mm or less, 12 mm or less, or 10 mm or less.

The length of the narrowing region as measured along the axis of the flow channel may vary, and in some instances is between 2 mm and 10 mm, such as between 4 mm and 8 mm. In some instances, the length of the narrowing region 104 is 2 mm or less, 3 mm or less, 4 mm or less, 5 mm or less, 6 mm or less, 7 mm or less, 8 mm or less, 9 mm or less, 10 mm or less, 2 mm or more, 3 mm or more, 4 mm or more, 5 mm or more, 6 mm or more, 7 mm or more, 8 mm or more, 9 mm or more, 10 mm or more, and so forth. The narrow end of the narrowing region 104 may be between 0.05 mm and 2 mm, 0.1 mm and 1 mm, 0.1 mm and 0.5 mm, 0.1 mm and 0.25 mm. In some instances, the narrow end of the narrowing region 104 may vary, and in some instances may be 2 mm or less, 1 mm or less, 0.5 mm or less, 0.25 mm or less, 0.13 mm or less, 0.1 mm or less, 2 mm or more, 1 mm or more, 0.5 mm or more, 0.25 mm or more, 0.13 mm or more, or 0.1 mm or more. The wide end of the narrowing region 104 may vary, and in some instances is between 1 mm and 10 mm, between 2 mm and 8 mm, between 4 and 6 mm, and so forth. In some instances the wide end of the narrowing region 104, which is oriented toward the inlet side of the flow cell cuvette 102, may be 10 mm or less, 8 mm or less, 6 mm or less, 5 mm or less, 4 mm or less, 3 mm or less, 2 mm or less, 1 mm or less, 8 mm or more, 6 mm or more, 5 mm or more, 4 mm or more, 3 mm or more, 2 mm or more, or 1 mm or more. Opposing sides of the narrowing region 104 may be at an angle of between 5° and 40°, between 10° and 35°, between 15° and 30°, between 20° and 25°, less than 5°, less than 10°, less than 15°, less than 20°, less than 25°, less than 30°, less than 35°, less than 40°, less than 45°, more than 5°, more than 10°, more than 15°, more than 20°, more than 25°, more than 30°, more than 35°, more than 40°, more than 45°, and so forth. A side of the narrowing region 104 may be angled 25° or less, 20° or less, 15° or less, or 10° or less, away from the axis along the length of the flow channel 106.

The flow channel 106 may have a cross section (perpendicular to the axis of the flow channel) of any shape. In certain aspects, the flow channel 106 may have a rectangular or square cross section. The flow channel 106 may have a maximum cross-sectional width that varies, and in some instances is between 0.05 mm and 2 mm, 0.1 mm and 1 mm, 0.1 mm and 0.5 mm, such as 0.1 mm and 0.25 mm. In certain aspects the flow channel 106 may have a maximum cross-sectional width of 2 mm or less, 1 mm or less, 0.5 mm or less, 0.25 mm or less, 0.13 mm or less, 0.1 mm or less, 2 mm or more, 1 mm or more, 0.5 mm or more, 0.25 mm or more, 0.13 mm or more, 0.1 mm or more, and so forth. In certain aspects, the length of the flow channel 106 along its axis is between 5 mm and 12 mm, 7 mm and 10 mm, 5 mm or less, 7 mm or less, 10 mm or less, 12 mm or less, and so forth.

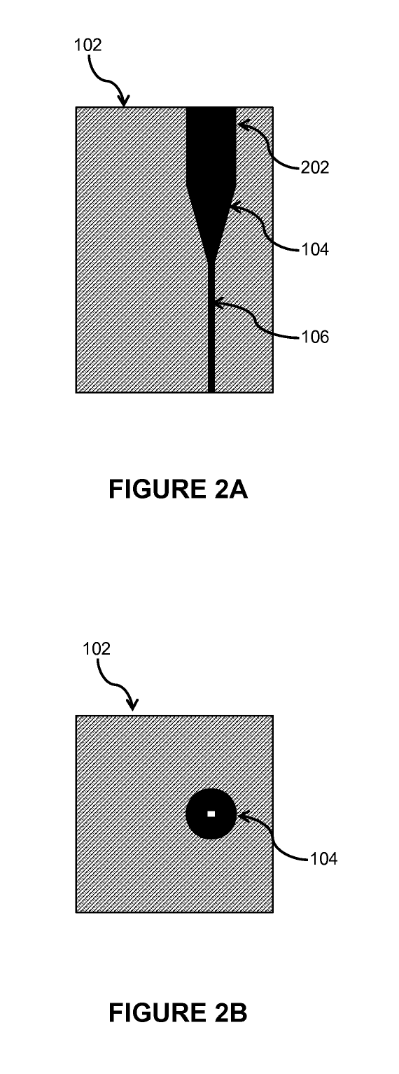

As seen in FIG. 2, in certain embodiments the flow cell cuvette 102 may have a cylindrical region 202 (i.e., a counterbore) in direct communication with the wide end of the narrowing region 104. The cylindrical region 202 may extend from the tope (inlet) side of the flow cell cuvette 102 as shown in FIG. 2A. The width of a cross section of the cylindrical region 202 may be between 2 mm and 10 mm, between 4 mm and 8 mm, 10 mm or less, 8 mm or less, 6 mm or less, 5 mm or less, 4 mm or less, 3 mm or less, 2 mm or less 1 mm or less, 8 mm or more, 6 mm or more, 5 mm or more, 4 mm or more, 3 mm or more, 2 mm or more, 1 mm or more, and so forth. The length of the cylindrical region may be between 2 and 10 mm, 4 and 8 mm, 3 and 7 mm, 4 and 6 mm, 10 mm or less, 8 mm or less, 6 mm or less, 5 mm or less, 4 mm or less, 3 mm or less, 2 mm or less, 15 mm or more, 12 mm or more, 10 mm or more, 8 mm or more, 6 mm or more, 5 mm or more, 4 mm or more, 3 mm or more, 2 mm or more, and so forth. The cylindrical region 202 may be coaxially aligned with one or both of the narrowing region 104 and the flow channel 106.

In certain aspects, a portion of the flow cell cuvette 102 is optically transmissive. The optically transmissive material may be silica, glass, clear plastic or any other suitable material. The optically transmissive portion may include the solid portion of the body of the flow cell cuvette that surrounds all or part of the flow cell channel 106. The optically transmissive portion may allow light to pass through opposing ends of the flow cell cuvette. The optically transmissive portion may allow light to pass through an assay region of the flow cell channel 106. The flow cell cuvette 102 may further include an additional material that is not optically transparent, such as an opaque plastic, metal, or any other suitable material.

The flow cell cuvette itself 102 may have one or more flat sides. For example, a cross section of the flow cell cuvette 102 (perpendicular to the axis of the flow channel) may be rectangular. The body of the flow cell cuvette 102 may comprise a rigid material, i.e., which maintains its shape even under physical stress. Rigid materials include silica, glass, certain clear plastics, metals, or any other suitable material that has the rigidity described below for the body of the flow cell cuvette 102. The body of the flow cell cuvette 102 may have a shear modulus (i.e., the ratio of the force to the area on which the force is applied, divided by the ratio of the transverse displacement over the initial length). In certain aspects, the body of the flow cell cuvette 102 may have a shear modulus between 0.1 GPa and 200 GPa, between 0.5 GPa and 200 GPa, between 1 GPa and 200 GPa, between 1 GPa and 100 GPa, between 5 GPa and 100 GPa, between 10 GPa and 50 GPa, between 20 GPa and 40 GPa, more than 0.1 GPa, more than 0.5 GPa, more than 1 GPa, more than 5 GPa, more than 10 GPa, more than 20 GPa, more than 30 GPa, more than 40 GPa, more than 50 GPa, and so forth.

In certain embodiments, the flow cell cuvette 102 may include (be physically coupled to) an optical element (e.g., lens, mirror, etc.). The optical element may facilitate optical detection and measurement of particles in a sample passed through the flow channel 106. Examples of an optical element include a focus lens, a fluorescence objective lens, a light filter (e.g., bandpass filters), a dichroic mirror, and so forth. Such optical elements may be fixed (attached to) a side of the flow cell cuvette 102, proximal to the flow channel 106. As described in the next section, the flow cell cuvette 102 may be coupled to one or more optical elements, e.g., via an index-matched gel. Flow cell cuvettes coupled to an optical element are discussed in U.S. Pat. Nos. 7,110,192 and 7,201,875, which are incorporated herein by reference.

The flow cell cuvette 102 may have features that facilitate the incorporation (e.g., attachment, mounting) of the flow cell cuvette 102 into a flow cytometer. For example, the body of the flow cell cuvette 102 may include one or more lips and/or divots that allows the flow cell cuvette 102 to be secured to one or more components of the flow cytometer, such as a flow chamber, x-y-z stage, nozzle, or any other suitable component. The features on the flow cell cuvette 102 may allow the flow cell cuvette 102 to be snapped into place, clamped down, screwed in, or otherwise secured by any suitable means.

The cuvettes can be made using any convenient protocol. For example, cuvettes may be cast in a mold. Alternatively or in addition, cuvettes may be cut (e.g., by laser cutting, sawing, die cutting, etc.) to achieve sides and internal structure (narrowing region, flow channel, optional cylindrical region, etc.) according to the desired dimensions. The flow cell cuvette may be made from an optically transmissive material, such as silica, glass, clear plastic, or any other suitable material.

### Flow Cytometers

As summarized above, aspects of the invention include a flow cytometer incorporating a flow cell cuvette. The flow cell cuvette includes a narrowing region in communication with a flow channel, and may be of any of the embodiments described in the next section. In certain aspects, the flow cell cuvette may be removable from the flow cytometer. For example, the body of the flow cell cuvette may include one or more lips and/or divots that allows the flow cell cuvette to be secured to one or more components of the flow cytometer, such as a flow chamber, x-y-z stage, nozzle, or any other suitable component. The features on the flow cell cuvette 102 may allow the flow cell cuvette to be snapped into and out of place, clamped and unclamped, screwed in and unscrewed, or otherwise mounted and removed by any suitable means.

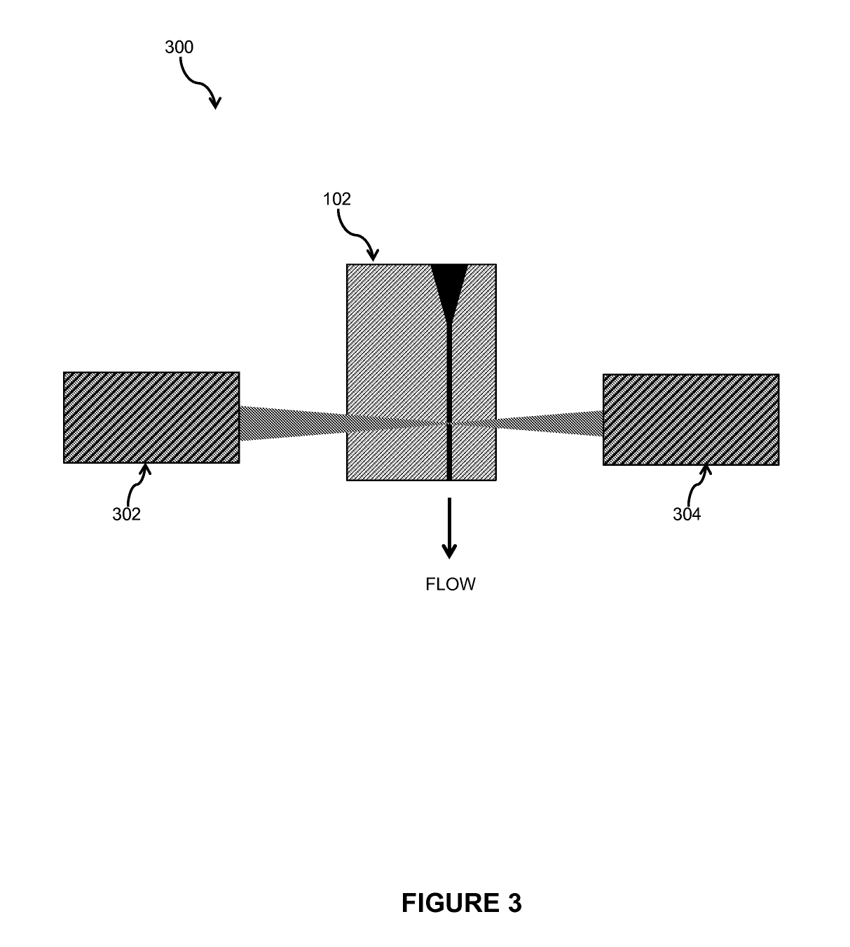

FIG. 3 is a schematic representation of a flow cytometer 300 having a flow cell cuvette 102 of the subject invention. The flow cell cuvette 102 may be of any of the above described embodiments. The flow cell cuvette 102 may be removable from the flow cytometer 300. The flow cytometer 300 may further include a light source 302 configured to irradiate an assay region (i.e., light source intersect) of the flow channel of the flow cell cuvette. Examples of light sources include lasers (e.g., argon, krypton, dye lasers, etc.), light emitting diodes, and arc lamps (e.g., with one or more optical filters). The light source 302 may be oriented such that the axis of irradiation is perpendicular to a flat side of the flow cell cuvette 102. In addition, the light source 302 may be oriented such the axis of irradiation is perpendicular to a flat side of the flow channel 106. A focus lens (not shown) may be positioned between the light source and the flow cell cuvette so as to focus light emitted from the light source 302 at the assay region of the flow channel. The light source 302 may be configured to irradiate the assay region with white light, a range of light, or monochromatic light.

The flow cytometer 300 further includes a photodetector 304 positioned so as to receive light from the assay region of the flow channel 106. Any suitable photodetector may be used, such as a photodiode, a photomultiplier tube, or any other light detecting element. Although only one photodetector 304 is shown, multiple photodetectors may be included in the flow cytometer. A photodetector 304 may be configured to receive light scatter, such as forward light scatter (FSC) or side light scatter (SSC), or axial light loss (ALL). Cell size, cell granularity, and other physical characteristics of the cell affect light scatter and ALL. An FSC photodetector may be positioned to receive light between 1 to 20 degrees off the axis of irradiation. An SSC photodetector may be positioned orthogonal to the axis of irradiation, from the assay region.

In certain aspects, the flow cytometer 300 may include an optical setup (not shown) configured to deliver light from the assay region of the flow channel, optionally of a specific wavelength or range of wavelengths, to the photodetector 304. The light detection optics may include one or more fluorescence objective lenses, light filters (e.g., bandpass filters), dichroic mirrors, light collection fibers (e.g., optical fibers), or any other optics suitable for use in the present invention. The flow cell cuvette 102 may be coupled to one or more optical elements (e.g., focus lens, fluorescence objective lens, etc.) by an index-matched gel or fluid. One or more of the flow cell cuvette 102, elements of the optical setup, the light source 302, and the photodetector 304 may be mounted on an x-y-z stage to allow for precise alignment of the optics. The photodetector 304 may be coupled to an analogue-to-digital conversion (ADC) system (not shown) configured to generate digital signals that may be processed by a computer. In certain aspects, the flow cytometer 300 may be in a stream-to-air configuration in which the light source 302 and the photodetector 304 are configured to assay sample exiting the flow cell cuvette 102.

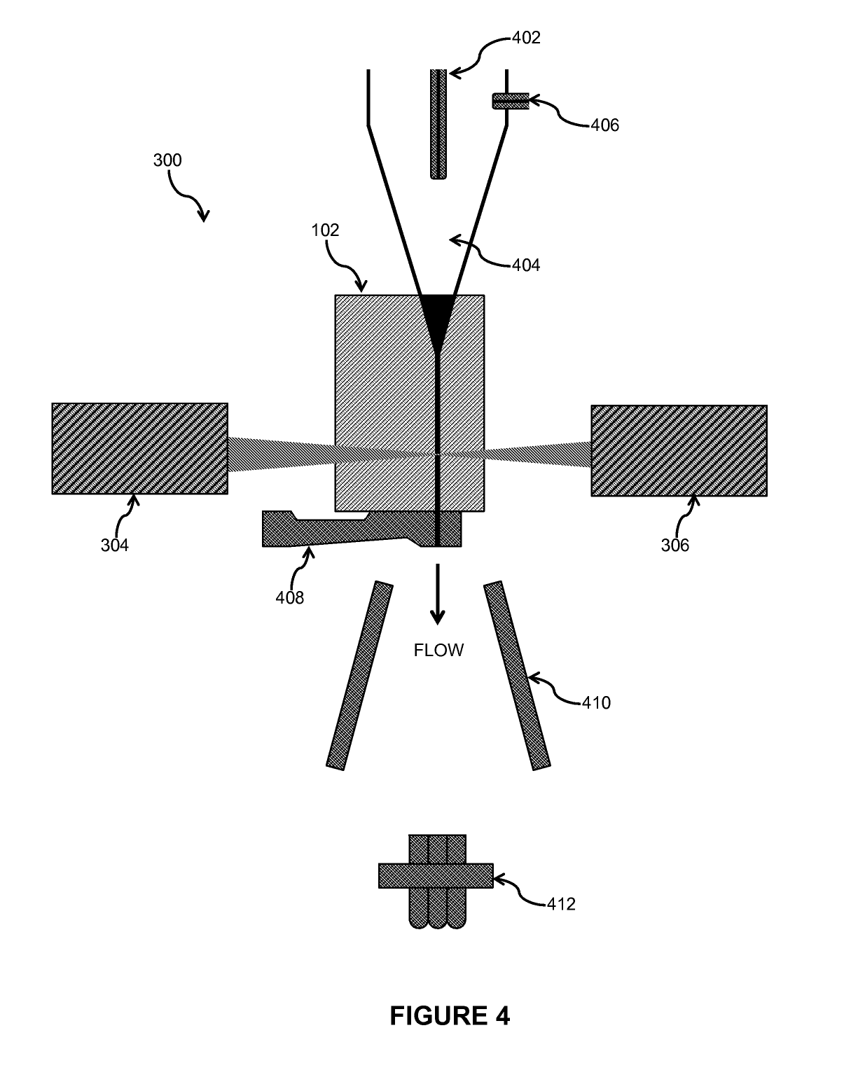

FIG. 4 is a schematic representation of a flow cytometry system 300 having a flow cell cuvette 102 of the subject invention and configured to sort particles. The flow cytometer 300 of FIG. 3 may further include one or more of the additional elements shown in FIG. 4. In certain aspects, the flow cytometer 300 includes a sample inlet port 402 configured to flow a sample into a flow chamber 404. The flow chamber 404 may converge to meet the narrowing region 104 of the flow cell cuvette 102 (e.g., as seen in FIG. 1) or the cylindrical region 202 of the flow cell cuvette 102 (e.g., as seen in FIG. 2). The angle between sides of the flow chamber 404 may be identical or similar to the angle between the sides of the narrowing region 104. The flow chamber 404 may be aligned with the axis of the flow channel of the flow cell cuvette 102. A sheath fluid port 406 may be configured to flow an index-matched sheath fluid into the flow chamber 404 from a sheath fluid container (not shown). The index-matched sheath fluid may match the refractive index of an optically transmissive portion of the flow cell cuvette 102. In addition, the flow cytometer 300 may be configured to generate a pressure differential between the flow chamber 402 and the opposing (outlet) end of the flow cell cuvette 102, so as to facilitate flow of the sample though the flow cell cuvette 102. In certain aspects, a compressor may be configured to supply air pressure to drive sheath fluid into the flow chamber 404, thereby generating the pressure differential.

In certain embodiments, the flow cytometer 300 may be a sorting flow cytometer capable of sorting particles in the sample into different containers (such as collection tubes, a waste container, and so forth). As such, the flow cytometer 300 may include a nozzle 408 positioned to receive sample from the flow channel 102 of the flow cell cuvette 102. The nozzle 408 may have a flow channel in communication with the flow channel 106 of the flow cell cuvette 102.

The maximum width of the flow channel of the nozzle 408 may be 50 um to 200 um, 80 to 150 um, 100 to 130 um, more than 50 um, more than 80 um, more than 100 um, more than 130 um, more than 150 um, less than 80 um, less than 100 um, less than 130 um, less than 150 um, less than 200 um, and so forth. Sample flowed through the nozzle 408 may be separated into droplets by a droplet generator (not shown). The droplet generator may be positioned at any suitable location, such as at the nozzle 408, sheath fluid port 406, flow chamber 404, sample inlet port 402, flow cell cuvette 102, and so forth. The droplet generator may be configured to vibrate the sample so as to generate droplets from sample exiting the nozzle 408. For example, the droplet generator may indirectly impart oscillating pressure to the sample by vibrating an element of the flow cytometer 300, such as at the nozzle 214, sheath fluid port 406, flow chamber 204, sample inlet port 208, flow cell cuvette 102, and so forth. In another example, the droplet generator may be in direct contact with the fluid (i.e., sample and sheath fluid) and may directly impart oscillating pressure. The flow cytometer may further be configured to charge droplets exiting the nozzle 408.

The flow cytometer may further include one or more deflection plates 410 positioned to deflect charged droplets exiting the nozzle 408. The deflection plates 410 may be two oppositely charged plates. The polarity and magnitude of the charges of the deflection plates 410 may adjust the trajectory of droplets exiting the nozzle 408 to deliver droplets to specific containers (e.g., tubes) in a collection device 412. Alternatively, the collection device may be moved to capture individual droplets in separate containers or tubes (e.g., without the need for charging the drops or for the deflection plates 410).

Flow cytometers may further include data acquisition, analysis and recording means, such as a computer, wherein multiple data channels record data from each detector for the light scatter and fluorescence emitted by each particle as it passes through the sensing region. The purpose of the analysis system is to classify and count particles wherein each particle presents itself as a set of digitized parameter values. The flow cytometer may be configured to produce a data set. The data set may include signal data (e.g., fluorescence excitation and/or emission spectra, fluorescence intensity, fluorescence emission maxima, FSC, SSC, ALL or combinations thereof) for each event in the data set.

The flow cytometry system may also include a “data processing unit”, e.g., any hardware and/or software combination that will perform the functions required of it. For example, any data processing unit herein may be a programmable digital microprocessor such as available in the form of an electronic controller, mainframe, server or personal computer (desktop or portable). Where the data processing unit is programmable, suitable programming can be communicated from a remote location to the data processing unit, or previously saved in a computer program product (such as a portable or fixed computer readable storage medium, whether magnetic, optical or solid state device based).

The flow cytometry system may further include a “memory” that is capable of storing information such that it is accessible and retrievable at a later date by a computer. Any convenient data storage structure may be chosen, based on the means used to access the stored information. In certain aspects, the information may be stored in a “permanent memory” (i.e. memory that is not erased by termination of the electrical supply to a computer or processor) or “non-permanent memory”. Computer hard-drive, CD-ROM, floppy disk and DVD are all examples of permanent memory. Random Access Memory (RAM) is an example of non-permanent memory. A file in permanent memory may be editable and re-writable.

Suitable flow cytometry systems and methods for analyzing samples include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSVantage™, BD Biosciences FACSort™, BD Biosciences FACSCount™, BD Biosciences FACScan™, and BD Biosciences FACSCalibur™ systems, a BD Biosciences Influx™ cell sorter, BD Biosciences Jazz™ cell sorter and BD Biosciences Aria™ cell sorter or the like.

In certain embodiments, the subject systems are flow cytometer systems which incorporate one or more components of the flow cytometers described in U.S. Pat. Nos. 3,960,449; 4,347,935; 4,667,830; 4,704,891; 4,770,992; 5,030,002; 5,040,890; 5,047,321; 5,245,318; 5,317,162; 5,464,581; 5,483,469; 5,602,039; 5,620,842; 5,627,040; 5,643,796; 5,700,692; 6,372,506; 6,809,804; 6,813,017; 6,821,740; 7,129,505; 7,201,875; 7,544,326; 8,140,300; 8,233,146; 8,753,573; 8,975,595; 9,092,034; 9,095,494 and 9,097,640; the disclosures of which are herein incorporated by reference.

In certain aspects, the flow cytometer may be configured to process a sample according to any of the methods described below.

### Methods

As described above, embodiments of the invention are directed to methods of processing particles in a sample. In certain aspects, the particles may be cells. The methods may employ any of the flow cell cuvettes and flow cytometry systems of the invention, e.g., as described above.

A method of the subject invention includes flowing a sample from a flow cell chamber through a narrowing region of a flow cell cuvette, where the narrow end of the narrowing region terminates in a flow channel.

Where desired, the method may further include irradiating an assay region of the flow channel. The step of irradiation may include directing light from one or more light sources toward an assay region of the flow channel. The spectrum of the light may be either narrow (monochromatic) or broadband, and may be in the UV, visible, and/or infrared range.

Where desired, the method may further include detecting a signal from the assay region of the flow channel. Detecting may include recording light that passes through each particle (generally referred to as forward light scatter), light that is reflected orthogonal to the direction of the flow of the particles through the sensing region (generally referred to as orthogonal or side light scatter), light loss along the axis of irradiation (generally referred to as axial light loss), and fluorescent light emitted from the particles as the particle passes through the sensing region and is illuminated by the energy source. Forward light scatter (or FSC), orthogonal light scatter (SSC), axial light loss (ALL) and one or more fluorescence signals may each constitute a separate parameter for each particle (i.e. each “event”). A fluorescence signal may include fluorescence emission maxima, fluorescence polarization, fluorescence lifetime, or a combination thereof.

In certain aspects, the method may further include generating a pressure differential between the flow cell chamber and the opposing end of the flow cell cuvette. The pressure differential may be between 5 psi and 100 psi. For example, the pressure differential may be 40 psi or less, 30 psi or less, 25 psi or less, 20 psi or less, 15 psi or less, 10 psi or less, 5 psi or less, and so forth. In certain aspects, the pressure at the outlet end of the flow cell cuvette may be the atmospheric pressure (e.g., 14.7 psi at sea level), and the step of generating a pressure differential may involve generating a pressure at the inlet end of the flow channel (e.g., in the flow chamber) of 20 psi or less, 25 psi or less, 30 psi or less, 40 psi or less, 45 psi or less, 50 psi or less, 60 psi or less, 80 psi or less, or 100 psi or less, and so forth. The narrowing region of the flow cell cuvette may allow for sorting at a reduced pressure differential.

In certain aspects, the method further includes generating droplets from a sample that has passed through the flow channel of the flow cell cuvette. The droplets may be charged to allow for sorting. The method may further include determining one or more settings for droplet generation, such as frequency, amplitude, phase, drop delay, and attenuation. For example, the method may include generating droplets at a frequency of 80 kHz or more, 90 kHz or more, 100 kHz or more, 105 kHz or more, 110 kHz or more, and so forth.

In flow cytometrically assaying particles, the flow cytometer may be set to trigger on a selected parameter in order to distinguish the particles of interest from background and noise. “Trigger” refers to a preset threshold for detection of a parameter. It is typically used as a means for detecting passage of particle through the laser beam. Detection of an “event” (e.g., a particle such as a bead or cell) that exceeds the preset threshold for the selected parameter triggers acquisition of light scatter and fluorescence data for the particle. Data is not acquired for particles or other components in the medium being assayed which cause a response below the threshold. The trigger parameter may be the detection of forward scattered light caused by passage of a particle through the light beam. The flow cytometer then detects and collects the light scatter and fluorescence data for particle. The flow cytometer may thereby produce a data set (e.g., signal data such as FSC, SSC, fluorescence emission, etc. from each event).

A particular population of interest may be categorized (e.g., “gated”) based on the data set collected for the entire sample. To select an appropriate gate, the data set is plotted so as to obtain the best separation of populations possible. This procedure is typically done by plotting forward light scatter (FSC) vs. side (i.e., orthogonal) light scatter (SSC) on a two dimensional dot plot (e.g., a linear or log scale scatter plot). Particles (e.g. cells, beads, also referred to as “events”) may be gated into separate populations based on differences in FSC and/or SSC intensity. For example, populations may differ from one another in FSC and/or SSC intensity by two-fold or more, five-fold or more, or ten-fold or more. The flow cytometer operator then selects the desired population of particles (i.e., those cells within the gate) and excludes particles that are not within the gate. Where desired, the operator may select the gate by drawing a line around the desired subpopulation using a cursor on a computer screen. Only those particles within the gate are then further analyzed by plotting (e.g., on a linear or log scale) the other parameters for these particles, such as fluorescence. Gating based on fluorescence may then be used to further categorize populations of cells. Particles may be gated into separate populations based on fluorescence emission, a lack of fluorescence emission, differences in fluorescence (e.g. fluorescence emission maxima), or light scatter.

The method may further include isolating cells from the sample based on the detected signal. In certain aspects, droplets containing cells to be isolated (e.g., collected) may be charged, and deflection plates may deflect the droplets into the appropriate containers in a collection block, as discussed above. “Gating”, as discussed above, may be performed to identify cells to be collected in this way.

### Experimental

Flow cell cuvettes having a narrowing region (tapered cone) and a flow channel with a 0.25 mm by 0.25 mm rectangular cross section and either 7 mm or 10 mm long flow channel were manufactured. An overall increase in cell viability was observed in cells processed using the flow cell cuvettes of the subject invention as compared to a standard flow cell cuvette (without a narrowing region). In addition, samples run using the flow cell cuvettes of the subject invention could be run at a higher frequency (more drops per second).

Notwithstanding the appended clauses, the disclosure set forth herein is also defined by the following clauses:
1. A flow cytometer flow cell cuvette, the flow cell cuvette comprising:

a narrowing region comprising a wide end opposite a narrow end; and

a flow channel extending from the narrow end of the narrowing region;

wherein at least a portion of the flow cell cuvette comprises an optically transmissive solid.
2. The flow cell cuvette according to Clause 1, further comprising a cylindrical region extending from the wide end of the narrowing region.
3. The flow cell cuvette according to Clause 1 or 2, wherein the narrowing region comprises a frustoconical configuration.
4. The flow cell cuvette according to any of Clauses 1 to 3, wherein the flow cell cuvette comprises one or more flat sides.
5. The flow cell cuvette according to any of Clauses 1 to 4, wherein the flow cell cuvette comprises a rigid material.
6. The flow cell cuvette according to any of Clauses 1 to 5, wherein both the narrowing region and the flow channel are permanently integrated within the flow cell cuvette.
7. The flow cell cuvette according to any of Clauses 1 to 6, wherein the optically transmissive portion of the flow cell cuvette is configured to allow optical detection of particles in the flow channel.
8. The flow cell cuvette according to any of Clauses 1 to 7, wherein the optically transmissive portion of the flow cell cuvette has a rectangular cross section.
9. The flow cell cuvette according to any of Clauses 1 to 8, wherein the narrowing region and the flow channel are coaxially aligned.
10. The flow cell cuvette according to any of Clauses 1 to 9, wherein a side of the narrowing region is angled 15 degrees or less away from the axis along the length flow channel.
11. The flow cell cuvette according to any of Clauses 1 to 10, wherein the maximum width of the wide end of the narrowing region is 2 mm or less.
12. The flow cell cuvette according to any of Clauses 1 to 10, wherein the maximum width of the wide end of the narrowing region is 1 mm or less
13. The flow cell cuvette according to any of Clauses 1 to 11, wherein the maximum width of the narrow end of the narrowing region is 0.5 mm or less.
14. The flow cell cuvette according to any of Clauses 1 to 13, wherein the axial length of the narrowing region is 5 mm or less.
15. The flow cell cuvette according to any of Clauses 1 to 13, wherein the axial length of the narrowing region is 3 mm or less.
16. The flow cell cuvette according to any of Clauses 1 to 15, wherein the length of the flow channel is 12 mm or less.
17. The flow cell cuvette according to any of Clauses 1 to 16, wherein the flow channel has a maximum cross-sectional width of 0.5 mm or less.
18. The flow cell cuvette according to any of Clauses 1 to 17, wherein the flow channel comprises a rectangular cross-sectional shape.
19. The flow cell cuvette according to Clause 2, further comprising a cylindrical region extending from the wide end of the narrowing region.
20. The flow cell cuvette according to Clause 19, wherein the length of the cylindrical region is 2 mm or more.
21. A flow cytometry system, the system comprising:

a flow cell cuvette comprising:
a narrowing region; and
a flow channel extending from the narrow end of the narrowing region;

a light source configured to irradiate an assay region of the flow channel; and

a photodetector configured to receive light from the assay region of the flow channel;

wherein at least a portion of the flow cell cuvette is optically transmissive.
22. The flow cytometry system of Clause 21, further comprising a flow cell chamber in communication with the narrowing region of the flow cell cuvette.
23. The flow cytometry system according to Clause 21 or 22, wherein the flow cell cuvette is removable.
24. The flow cytometry system according to any of Clauses 21 to 23, further comprising a nozzle secured to the flow cell cuvette and configured to receive fluid exiting the flow channel of the flow cell cuvette.
25. The flow cytometry system according to any of Clauses 21 to 24, further comprising a droplet generator configured to generate droplets from fluid passed through the flow channel of the flow cell cuvette.
26. The flow cytometry system according to Clause 25, further comprising deflection plates positioned so as to deflect droplets exiting the nozzle.
27. The flow cytometry system according to Clause 25 or 26, further comprising a collection device positioned so as to collect droplets exiting the nozzle.
28. The flow cytometry system according to any of Clauses 21 to 27, wherein the flow chamber comprises a sample delivery tube.
29. The flow cytometry system according to any of Clauses 21 to 28, wherein the flow chamber comprises a sheath fluid port.
30. The flow cytometry system according to Clause 29, further comprising a sheath fluid container configured to deliver an index-matched fluid through the sheath fluid delivery port, wherein the index-matched fluid has a refractive index similar to the refractive index of the optically transmissive portion of the flow cell cuvette.
31. The flow cell cuvette system according to any of Clauses 21 to 30, wherein the flow cell cuvette further comprises a cylindrical region extending from the wide end of the narrowing region.
32. The flow cell cuvette system according to any of Clauses 21 to 30, wherein the narrowing region comprises a frustoconical configuration.
33. The flow cell cuvette system according to any of Clauses 21 to 32, wherein the flow cell cuvette comprises one or more flat sides.
34. The flow cell cuvette system according to any of Clauses 21 to 33, wherein the flow cell cuvette comprises a rigid material.
35. The flow cell cuvette system according to any of Clauses 21 to 34, wherein both the narrowing region and the flow channel are permanently integrated within the flow cell cuvette.
36. The flow cell cuvette system according to any of Clauses 21 to 35, wherein the optically transmissive portion of the flow cell cuvette is configured to allow optical detection of particles in the flow channel.
37. The flow cell cuvette system according to any of Clauses 21 to 36, wherein the optically transmissive portion of the flow cell cuvette has a rectangular cross section.
38. The flow cell cuvette system according to any of Clauses 21 to 37, wherein the narrowing region and the flow channel are coaxially aligned.
39. The flow cell cuvette system according to any of Clauses 21 to 38, wherein a side of the narrowing region is angled 15 degrees or less away from the axis along the length flow channel.
40. The flow cell cuvette system according to any of Clauses 21 to 39, wherein the maximum width of the wide end of the narrowing region is 2 millimeters or less.
41. The flow cell cuvette system according to any of Clauses 21 to 40, wherein the maximum width of the narrow end of the narrowing region is 0.5 millimeters or less.
42. The flow cell cuvette system according to any of Clauses 21 to 41, wherein the axial length of the narrowing region is 5 millimeters or less.
43. The flow cell cuvette system according to any of Clauses 21 to 42, wherein the length of the flow channel is 12 millimeters or less.
44. The flow cell cuvette system according to any of Clauses 21 to 43, wherein the flow channel has a maximum cross-sectional width of 0.5 millimeters or less.
45. The flow cell cuvette system according to any of Clauses 21 to 44, wherein the flow channel comprises a rectangular cross-sectional shape.
46. The flow cell cuvette system according to Clause 45, wherein the flow cell cuvette further comprises a cylindrical region extending from the wide end of the narrowing region, wherein the length of the cylindrical region is 2 millimeters or more.
47. The flow cell cuvette system according to Clause 46, wherein the length of the cylindrical region is 5 millimeters or more.
48. A method of processing particles in a sample, the method comprising:

flowing a sample from a flow cell chamber through a narrowing region of a flow cell cuvette, wherein the narrow end of the narrowing region terminates in a flow channel.
49. The method according to Clause 48, further comprising irradiating an assay region of the flow channel.
50. The method according to Clause 49, further comprising detecting a signal from the assay region of the flow channel.
51. The method according to Clause 50, further comprising isolating cells from the sample based on the detected signal.
52. The method according to any of Clauses 48 to 50, further comprising generating droplets from sample passed through the flow channel of the flow cell cuvette.
53. The method according to any of Clauses 48 to 52, wherein the droplets are generated at a frequency of 100 kHz or more.
54. The method according to any of Clauses 48 to 53, further comprising generating a pressure differential between the flow cell chamber and the opposing end of the flow cell cuvette.
55. The method according to any of Clauses 48 to 54, wherein the pressure differential is 20 psi or less.
56. The method according to Clause 55, wherein the pressure differential is 10 psi or less.
57. The method according to Clause 56, wherein the pressure differential is 5 psi or less.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A flow cytometer flow cell cuvette, the flow cell cuvette comprising:
a narrowing region comprising a wide end opposite a narrow end; and
a flow channel extending from the narrow end of the narrowing region;
wherein at least a portion of the flow cell cuvette comprises an optically transmissive solid.

2. The flow cell cuvette according to claim 1, further comprising a cylindrical region extending from the wide end of the narrowing region.

3. The flow cell cuvette according to claim 1 or 2, wherein the narrowing region comprises a frustoconical configuration.

4. The flow cell cuvette according to any of claims 1 to 3, wherein the flow cell cuvette comprises one or more flat sides.

5. The flow cell cuvette according to any of claims 1 to 4, wherein the flow cell cuvette comprises a rigid material.

6. The flow cell cuvette according to any of claims 1 to 5, wherein both the narrowing region and the flow channel are permanently integrated within the flow cell cuvette.

7. The flow cell cuvette according to any of claims 1 to 6, wherein the optically transmissive portion of the flow cell cuvette is configured to allow optical detection of particles in the flow channel.

8. The flow cell cuvette according to any of claims 1 to 7, wherein the optically transmissive portion of the flow cell cuvette has a rectangular cross section.

9. The flow cell cuvette according to any of claims 1 to 8, wherein the narrowing region and the flow channel are coaxially aligned.

10. The flow cell cuvette according to any of claims 1 to 9, wherein the maximum width of the wide end of the narrowing region is 2 mm or less, the axial length of the narrowing region is 5 mm or less, the length of the flow channel is 12 mm or less and the flow channel has a maximum cross-sectional width of 0.5 mm or less.

11. The flow cell cuvette according to claim 2, further comprising a cylindrical region extending from the wide end of the narrowing region.

12. The flow cell cuvette according to claim 11, wherein the length of the cylindrical region is 2 mm or more.

13. A flow cytometry system, the system comprising a flow cell cuvette according to any of claims 1 to 12

14. A method of processing particles in a sample, the method comprising:
flowing a sample from a flow cell chamber through a narrowing region of a flow cell cuvette according to any of claims 1 to 12.

15. The method according to claim 14, further comprising generating a pressure differential of 20 psi or less between the flow cell chamber and the opposing end of the flow cell cuvette.
